(19) United States
(12) Patent Application Publication
(10) Pub. No.: US 2002/0178184 A1
(43) Pub. Date: Nov. 28, 2002

(54) Software system for biological storytelling

(76) Inventors: Allan Kuchinsky, San Francisco, CA (US); Katherine Graham, San Jose, CA (US); David Chitai Moh, San Francisco, CA (US); Paul Meltzer, Rockville, MD (US); Yidong Chen, Rockville, MD (US); Michael Bittner, Rockville, MD (US); Michael L. Creech, Los Altos, CA (US)

Correspondence Address: AGILENT TECHNOLOGIES, INC., Legal Department, DL429, Intellectual Property Administration, P. O. Box 7599, Loveland, CO, 80537-0599, US

(21) Appl. No.: 09/863,115

(22) Filed: May 22, 2001

(51) Int. Cl. G06F 17/24

(52) U.S. Cl. 707/512

(57) ABSTRACT

Narrative structure and a free-form database to support biological storytelling. An interactive software system provides a framework, methodology, and tools for organizing information during speculative phases of research using a narrative structure. The system provides interactive tools and techniques for organizing, sharing, and using diverse information at multiple levels of abstraction through coordinated multiple-view visualization in the process of hypothesis formation. Items are created or imported through an item manager and can be grouped into collections using a collection manager. Items and collections are combined in a narrative structure through pathway and story editors. Annotation and collaboration are supported.

### FIELD OF THE INVENTION

The present invention pertains to software systems supporting the information synthesis activities of molecular biologists, in particular the activities of organizing, using, and sharing diverse biological information.

### BACKGROUND OF THE INVENTION

As in many fields, research in molecular biology moves through an initial phase involving the formulation of models or hypotheses, into a middle phase where these hypotheses are tested through experiment.

In the early phase of model building and hypothesis formation, the investigator engages in speculation and hypothesis formation, identifying key elements, genes and proteins in molecular biology, and possible interactions of those key elements. In this early phase, the investigator is inferring causal relationships from correlations in test data, forming hypotheses which are to be refined and possibly tested.

The investigator in the field of molecular biology faces a daunting task in this early phase of model building. Unlike earlier endeavors where the number of possible variables was small, and experiments few and contained, investigators in molecular biology deal with enormous problems of scope.

Key elements, such as genes or proteins of interest, may number in the thousands, and the potential interactions may number in the billions. A single microarray experiment may produce megabytes of numerical data. The data is too large in scope to be held in the investigator's head.

To add to this problem, the investigator is faced with piecing together information from diverse sources and in different forms. This information is also geographically diverse, both in content and form, and may include public and private databases, textual information from publications, and experimental data both raw and refined. This data is also at multiple levels of abstraction, ranging from raw numerical gene expression data from microarray experiments, to textual descriptions of cellular processes.

The investigator must synthesize information in various forms from various sources into high level models.

Very few tools exist to support this abstraction and exploration process. What is needed is a system for assisting investigators in the organization, using, and sharing of this diverse biological information.

### SUMMARY OF THE INVENTION

An interactive software system provides a framework, methodology, and tools for organizing information during speculative phases of research using a narrative structure. The system provides interactive tools and techniques for organizing, sharing, and using diverse information at multiple levels of abstraction through coordinated multiple-view visualization in the process of hypothesis formation.

### BRIEF DESCRIPTION OF THE DRAWINGS

The present invention is described with respect to particular exemplary embodiments thereof and reference is made to the drawings in which:

FIG. 1 shows the main windows of the invention,

FIG. 2 shows an item,

FIG. 3 shows the file menu,

FIG. 4 shows the Item Manager window,

FIG. 5 shows the Collection Manager window,

FIG. 6 shows a Collection Manager menu,

FIG. 7 shows the browser view of a story,

FIG. 8 shows a story in tree form,

FIG. 9 shows a story grammar, and

FIG. 10 shows an example story in XML form.

### DETAILED DESCRIPTION

The investigator in the biological arts is inundated by data, data appearing in a myriad of forms and from a myriad of sources. From this vast amount of data, the investigator seeks to find needles of causality in haystacks of correlation.

The goal of the investigator is to piece together a “story” of what a gene or protein does, and how it interacts in pathways with other genes or proteins and their products. Such a story might portray a cascading set of proposed causal relationships between, for example, gene expression states, e.g. “the gene PAX3-FKHR induces the genes Myogenin and MyoD, which in turn induce the gene My14, which in turn causes muscle cells to fail to differentiate and exit the cell cycle, which in turn leads to cell proliferation and full malignancy.”

Piecing together the story is an iterative and interactive process involving gathering information, organizing that information into concepts and categories, formulating and documenting tentative explanations and hypotheses, documenting those explanations and hypotheses via textual notes and graphical sketches, sharing those explanations and hypotheses with colleagues, and incorporating verification and feedback from colleagues into the story.

To support this iterative process, the system according to the present invention provides a coordinated set of interactive information organization and synthesis tools, built upon a simple conceptual model using a free-form database and a narrative structure, incorporating and building items, collections, and biological stories.

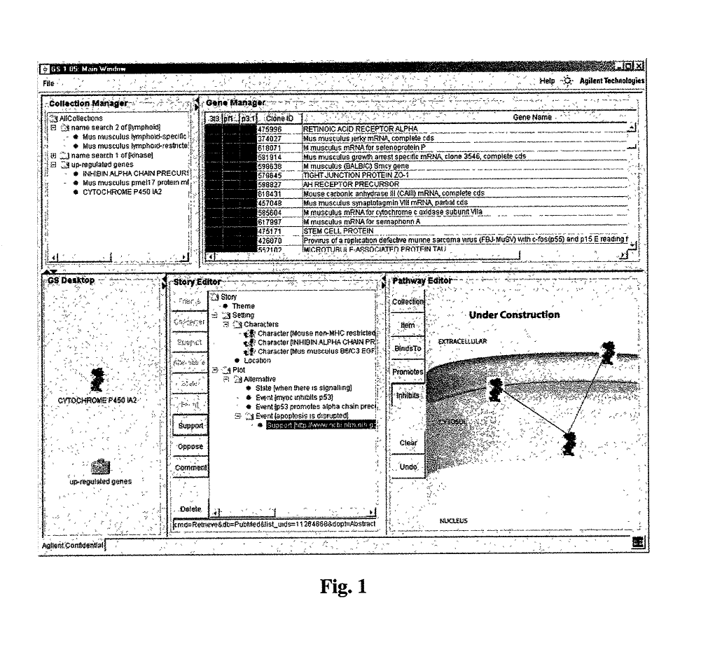

FIG. 1 shows the main windows of a system according to the present invention. In the preferred embodiment, the system is built as a java program to obtain portability across operating systems. Web and XML technology are used to represent and store information in a flexible fashion. While the implementation shown herein targets genes and gene expression, the techniques disclosed are equally useful for proteins and proteomics.

Items are handled by the Item Manager, shown in FIG. 1 as the Gene Manager window. Items are grouped into collections and handled by the Collection Manager. Multiple coordinated views of items and collections are supported, as is a desktop metaphor, the GS Desktop window of FIG. 1, for handling bookmarks and working sets of items and collections which may be the current focus of the investigation. Interactive updates to items in one view are reflected in changes in the corresponding views.

The Object Editor, not shown in FIG. 1, is a free-form tool provided for editing and annotating the properties and contents of items and collections.

The Story Editor shown in FIG. 1 is a syntax-directed editor in which a biological story is represented by a tree structure. The Story Editor provides a narrative structure for organizing information about the interrelationships and interactions amongst items and collections in biological pathways, and provides a way for the investigator to piece together and articulate an understanding of biological phenomena from diverse data sources.

The Pathway Editor allows the investigator to put together diagrams representing relationships between entities. The Pathway Editor also allows the construction of semantic overlays for items.

These components and their associated data structures are closely and consistently coupled. An interactive change to an entity in any one view is reflected in all other views. Consistency and close coupling of multiple views enables the investigator to simultaneously view information from a variety of perspectives and across different levels of abstraction. This facilitates the discovery of unforeseen interrelationships, this aiding the process of piecing together explanations and hypotheses.

### Items and Collections

Items are the basic or “atomic” units of information. They represent biological entities such as genes, proteins, sequences, or other products. Items contain detailed information about a biological entity, such as expression levels from microarray experiments. They also serve as repositories for links to detailed experimental data and public data, such as literature citations. The investigator moves Web based information on an entity into the item representing that entity by dragging and dropping (or cutting and pasting) text and/or URLs from a source such as a Web page (e.g. an NCBI Genbank entry for a gene) onto the appropriate item in the Item Manager.

In addition to providing ways for the investigator to manually enter links to detailed data, the system can also semi-automatically populate items with links to detailed data. For example, knowledge discovery and data mining tools can be utilized to retrieve pertinent literature references and database entries for an item.

In order to build new abstractions, it is often useful for the investigator to group together chunks of related information. For example, a set of genes known to influence muscle cell differentiation may be thought of together as a set. The system supports these sets through constructs known as collections. Collections are user-created, free-form sets of items.

The investigator groups items into collections by dragging and dropping items from the Item Manager onto the desired collection in the Collection Manager. The Collection Manager component is a tree view of collections; it functions in a way that is analogous to the tree view of folders in Windows Explorer. The investigator can create a new collection by using the add collection button in the Collection Manager.

The Collection Manager can also populate collections semi-automatically. One mechanism is by searching databases on a specified term. Using a dialogue box, the investigator enters a biological term of interest, for example, “kinase,” and a collection will be built consisting of items from a database whose names have a match for that term.

Collections are very malleable; collections may be split or merged, items or groups of items may be added, deleted, or moved from one collection to another. Collections may be nested; a collection can contain other collections as well as items. Collections cam be overlaid with detailed experimental data, for example by overlaying a set of expression levels on a collection of genes and highlighting those genes whose expression levels exceed a certain threshold.

As with items, collections can serve as repositories for links to detailed experimental data and public data, such as literature references. The investigator moves Web-based information on an item into the collection representing the item by dragging and dropping (or cutting and pasting) text and URLs from a Web page (e.g. and NCBI Genbank entry) onto the appropriate collection in the Collection Manager.

The biologist's starting point is a detailed, biological dataset, for example a gene expression dataset. The dataset is imported from a relational database, spreadsheet, or other bioinformatics tool. For example, this dataset may come from a spreadsheet that contains the results of running a number of DNA microarray experiments. In the simplest form, each row of the spreadsheet represents one gene and each column represents one experimental condition.

Proceeding from this detailed microarray data, the investigator pieces together the “story” of what a gene does and how it interacts in pathways with other genes and gene products. Such a story might portray a cascading set of causal relationships between gene expression states, e.g. “the gene PAX3-FKHR induces the genes Myogenin and MyoD, which in turn induce the gene My14, which in turn causes muscle cells to fail to differentiate and exit the cell cycle, which in turn leads to cell proliferation and full malignancy” [Khan et al, PNAS].

Piecing together the story is an iterative process of

gathering information,

organizing that information into concepts and categories,

formulating and documenting explanations and hypotheses,

documenting those explanations and hypotheses (via textual notes and graphical sketches),

sharing those explanations and hypotheses with colleagues, and

incorporating verification and feedback from colleagues into the story.

The present invention provides a method to make explicit and keep organized the train of thought leading to the investigator's explanations and hypotheses. To support this iterative process of story development, the invention provides a coordinated set of information organization and synthesis tools, built upon a simple conceptual model that consists of items, collections, and biological stories.

### Items

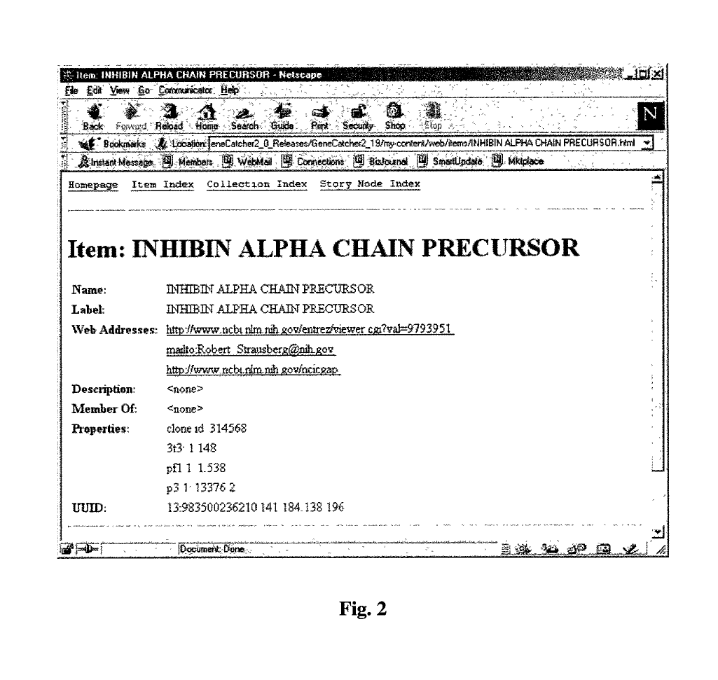

Items are the basic “atomic” unit of information. They represent biological entities such as genes, proteins, sequences, and other gene products. Items contain detailed information about a biological entity, such as the expression levels from multiple microarray experiments. They also serve as repositories for links to detailed experimental data and public data, such as literature citations. The investigator can move Web-based information for a gene into the item representing that gene by dragging and dropping (or cutting/copying and pasting) text and URLs from a Web page (e.g. an NCBI Genbank entry for a gene) onto the appropriate item in the Gene Manager. A sample item is shown in FIG. 2.

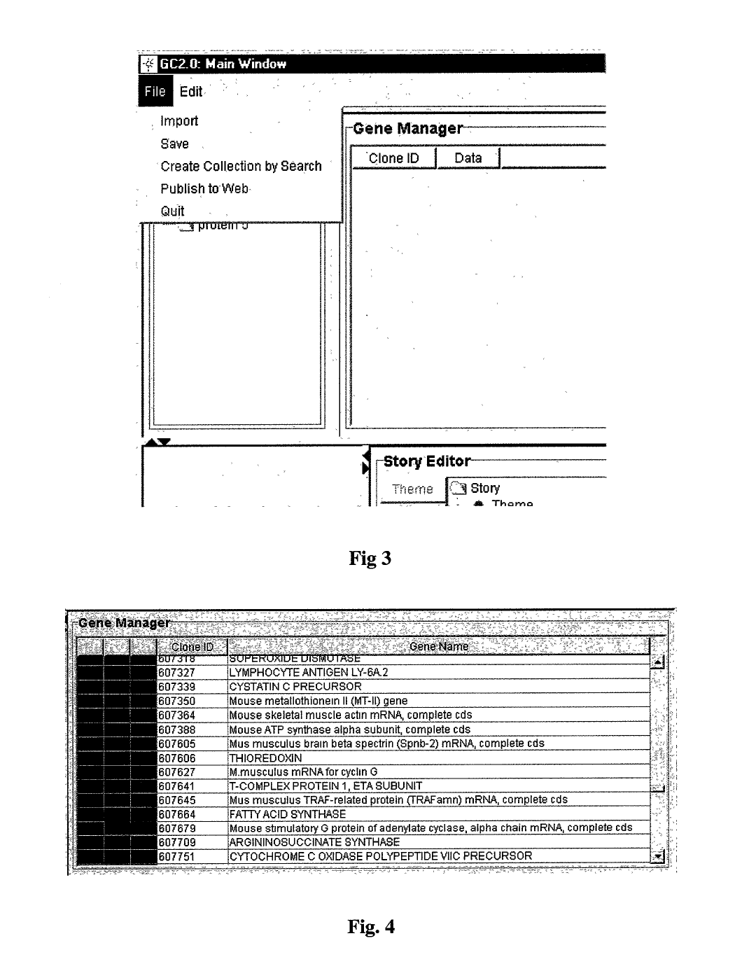

The investigator begins by importing the detailed dataset into the Gene Manager component by using the Import submenu on the File Menu. The File Menu is shown in FIG. 3.

The Gene Manager component consists of a table in which each row corresponds to an item and each column corresponds to a value or property for that value. This is analogous to a spreadsheet or a relational database table. FIG. 4 shows the GeneManager.

Selecting the File=>Import menu, prompts for a file to import, via a “file chooser” dialog. The import operation imports a set of gene data. Data is imported in the form of a spreadsheet with tab-separated columns. Each row of the spreadsheet data is read and used to create a new item that is added to the GeneManager. Properties and values are assigned to each item based upon the information imported from the appropriate columns. In order to correctly make assignments to items and their data values, the program relies on conventions on how columns are named. These naming conventions require two lines at the beginning of the input file. The first line is a version string and should take the form:

# gene data version 1.0

The second line is a specification of column names in the form

# ‘clone-id’ ‘gene-name’ ‘data-<col-num>-<name>’ ‘data-<col-num>-<name>’ . . . ‘data-<col-num>-<name>’

where ‘clone-id’ is the header for the clone id field and ‘gene name’ is the header for the gene name field. For example,

# clone-id gene-name data-1-UACC75 data-2-UACC89

The importer searches for a column named ‘gene-name’ and a column named ‘clone-id’. It searches for data fields with names according to the convention ‘data-<col-num>-<name>’ (e.g., data-1-px1.1), where col-num specifies the column in which to display the data value.

Mismatched double quotes, single quotes, and extra ending whitespace are removed from names.

The GeneManager presents a table view of an item and its properties. FIG. 4, shows columns representing a CloneID, a Gene Name, and a set of data values, in this situation expression ratios represented by a color encoding which runs from green (highly down-regulated) to red (highly up-regulated). The table may be sorted, using the values of any column as the sort key, by clicking on the column heading.

In addition to providing ways to manually enter links to detailed data, the software can also semi-automatically populate items with links to detailed data. For example, knowledge discovery and data mining tools can be utilized to retrieve pertinent literature references and public database entries for an item. In this present embodiment, the software fills in, for each imported item, a URL for the LocusLink entry for that item.

When a new dataset is imported, the default operation is to add the new data to any existing data, so this may result in a duplication of items. The existing dataset may be cleared by selecting the File=>Delete my Gene Data & Exit menu item or by pressing the “nuke” button shown in the bottom-right of FIG. 1.

### Collections

Often it is useful to group together “chunks” of related information, in order to build new abstractions or categories. For example, a set of genes known to influence muscle cell differentiation may be thought of together as a set. The program enables the investigator to group together “chunks” of related information via a construct known as collections. Collections are user-created, free-form sets of information. They can contain items and other collections.

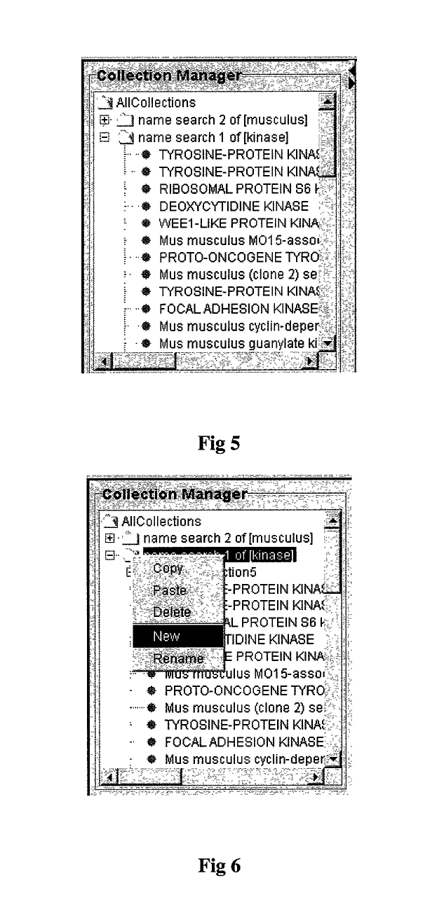

Items are grouped into collections by dragging and dropping (or cutting/copying and pasting) items from the Gene Manager onto the desired collection in the Collection Manager. The Collection Manager component is a tree view of collections; it functions in a way that is analogous to the tree view of folders in Windows Explorer. FIG. 5 shows the Collection Manager. New collection are created by pressing th e right mouse button in th e Collection Manager, then selecting the New menu item shown in FIG. 6.

Collections can also be built semi-automatically. One mechanism is by searching on a biological term. This is done by selecting the Create Collection by Search submenu on the File menu. A dialogue box will pop up, in which the investigator can enter a biological term, for example “kinase”, and a collection will be built consisting of items whose names have a match for that term.

Collections are very malleable: one can split and merge different collections, add items or groups of items, move items from one collection to another. Collections can be nested; a collection can contain other collections, as well as items. Collections can be overlaid with detailed experimental data, for example overlaying a set of expression levels on a collection of genes and highlighting those genes whose expression levels exceed a certain threshold. This is described in more detail in the section on semantic overlays.

Like items, collections can serve as repositories for links to detailed experimental data and public data, such as literature references. Web-based information on a gene may be moved into the collection representing that gene by dragging and dropping (or cutting/copying and pasting) text and URLs from a Web page (e.g. an NCBI Genbank entry for a gene) onto the appropriate collection in the collection manager shown in FIG. 4.

Along with the Gene Manager and Collection Manager, the present embodiment of the invention contains a GS Desktop pane, upon which items and collections of current interest can be dragged and dropped (or cut/copied and pasted). Dragging and dropping items and/or collections to this “desktop” pane creates a set of graphical “bookmarks.” This is a convenient way to set aside a small “working set” of items and collections which may be the current focal point of investigation. The Desktop has the same drag/drop (and cut/copy/paste) semantics as other software components in the program. For example, dragging an item from the Gene Manager and dropping it onto a collection on the Desktop adds the item to that collection.

### Biological Stories

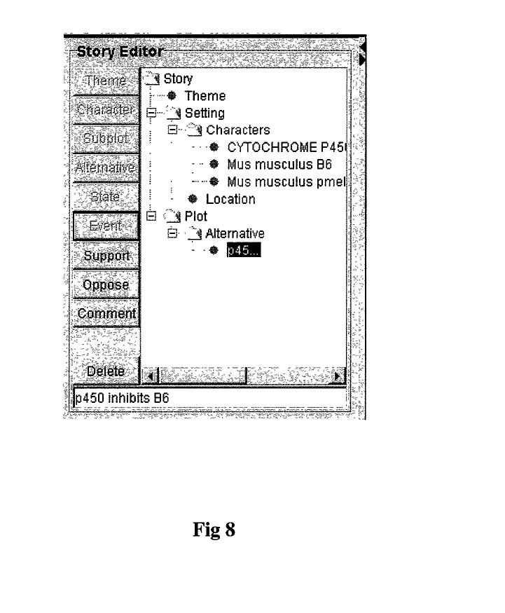

The next step in this process is the construction of biological stories, utilizing narrative structure to represent the state of the biologist's hypotheses and understandings. Narrative structure provides a framework for organizing information about the interrelationships and biological interactions amongst items and collections in biological pathways. Biological stories can be thought of as templates for organizing and describing what is going on in the cell. A biological story can also be thought of as the representation of a hypothesis and the train of thought that produced that hypothesis. The investigator can piece together knowledge about a biological phenomenon and compose a biological story by using the StoryEditor component shown in FIG. 8.

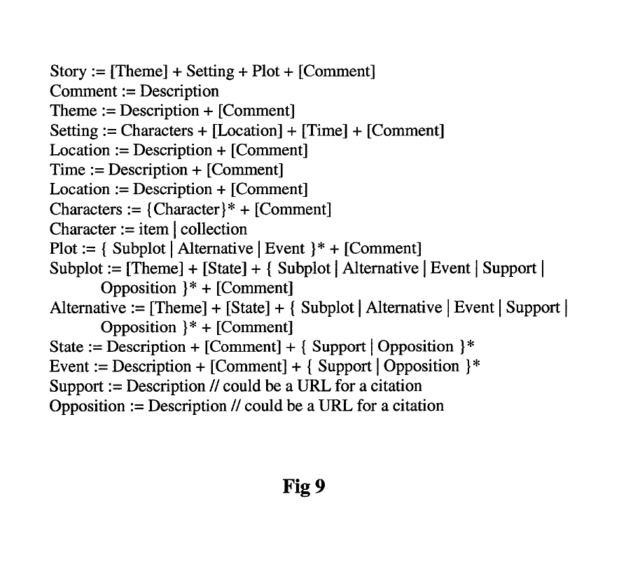

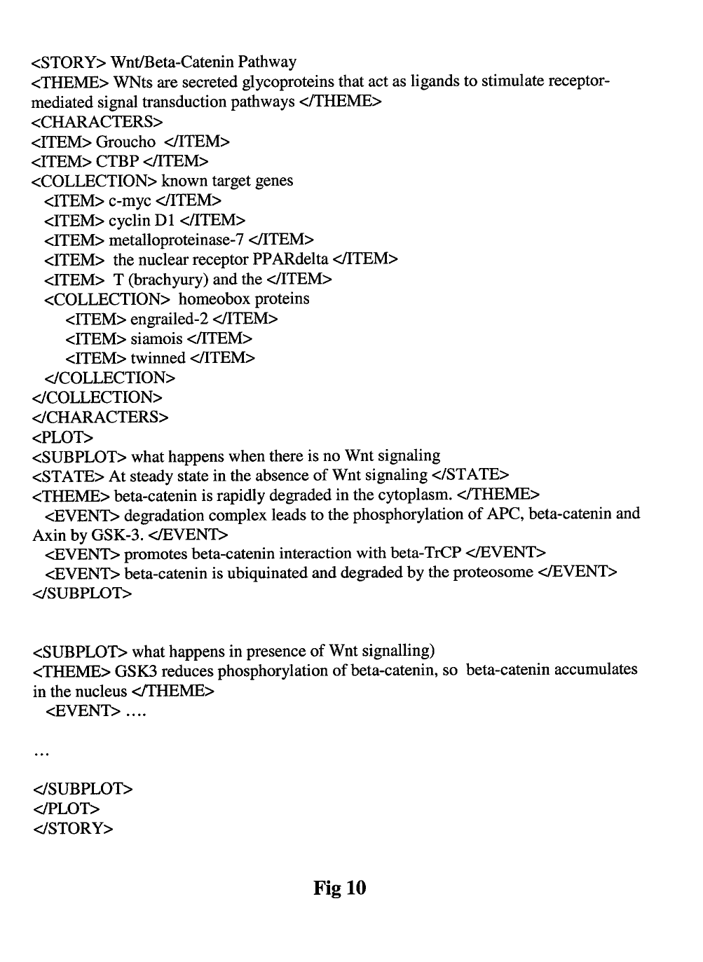

In the present invention, the narrative structure is organized around a story grammar, drawn from cognitive psychology research, and is shown in exemplary form in FIG. 9. Briefly, a Story consists of a Setting and a Plot and can also have a Theme. The Setting can contain a Location, a Time, and a set of Characters. The Plot can contain Events, Subplots, and Alternatives. Subplots and Alternatives can have a State associated with them. Events, Subplots, and Alternatives can all have justifications (either supporting or opposing) associated with them. Any of these story elements can take arbitrary annotations in the form of Comments. FIG. 10 shows an example story in XML form.

The StoryEditor component is a syntax-directed editor in which a biological story is represented by a tree structure. In this way, it is like an “outline processor”. The tree appears on a canvas on the right side of the StoryEditor component. Descriptions of biological phenomena are added to this tree, with nodes that correspond to the elements of narrative structure, i.e. Characters, Events, etc. On the left side of the StoryEditor component is a set of buttons, which are used for adding nodes to (or deleting nodes from) the tree. At the bottom of the StoryEditor component is a text entry field, which is used to enter textual information associated with story nodes. Story nodes can be added to and deleted from the tree and textual descriptions can be added to story nodes in the tree. Each story node represents an element of narrative structure: for example a Character, Subplot, or Event.

A story node can be added by pressing a button in the StoryEditor component, for example pressing the Character button to add a Character to a Setting. For any story node in the story, there is a valid set of story nodes that can be nested below it. For example, it is valid to add an Event to a Plot but not to a Setting. When a story node is added, the buttons representing the valid story nodes that can be nested below it are enabled, whereas the non-valid story nodes are disabled (grayed out).

The investigator typically starts building up a biological story by specifying the Characters in the story. The Characters in a biological story can be either Items or Collections. Characters are added to a story by dragging and dropping (or cutting/copying and pasting) them from the Gene Manager and/or the Collection Manager. Characters can also be added by pressing the Character button and typing a name into the text entry field.

Other information pertinent to the Setting of a biological story can be added. Such information can include a Location, e.g. a differentiating muscle cell, or temporal information, e.g. during cell death.

The Setting for a biological story, including Characters, Location, and Time, captures the context of a biological story. The other main aspect of a biological story is the representation of the episodic flow of the biological story. This is represented by the Plot of the biological story.

In its simplest form, the Plot of a biological story represents a sequence of Events. The investigator creates Events by selecting the Event button in the StoryEditor component, which causes an Event node to be added to the biological story. The investigator then enters a textual description of the biological Event by typing into the text entry field of the StoryEditor shown as the bottom text field in FIG. 8.

Sometimes it is useful to group Events together and provide a name for that grouping. For example, in building up a biological story related to a signal transduction pathway, the investigator may want to create 3 groups of Events to represent Events that occur before, during, and after signaling, respectively. In this situation, a Subplot node may be added to the Plot of the biological story, and then a sequence of Events added to that Subplot.

Another common situation is where there may be more than one possible explanation, alternative hypotheses for what is going on. This is often the case in the early phases of investigation, where there often are several possible explanations for a phenomenon. The present invention enables the investigator to add and keep track of all of the alternative hypotheses, and to evolve them as the biologists=3 understanding is refined. To represent an alternative hypothesis, add an Alternative node to the Plot of the biological story, then add a sequence of Events to that Alternative.

Since the investigator typically will have assumptions or evidence underlying different hypotheses, it is useful to keep track of these assumptions and evidence. Using the present invention, the investigator can add a Support node to a Plot, Subplot, Alternative, or Event shown as the buttons on FIG. 8. Similarly, information that contradicts a hypothesis may be tracked. This is done by adding an Oppose node to a Plot, Subplot, Alternative, or Event. Textual information may be added to the Support and/or Oppose nodes by typing into the StoryEditor's text panel. Database and literature citations may be added to the Support and/or Oppose nodes by dragging and dropping a URL from a Web page onto a Support or Oppose node.

### Putting the Story Together Graphically

Using the StoryEditor component, the biologist can build up a structured textual representation of a biological story. Many people think graphically and often use sketches and diagrams to represent their thinking about an explanation they are piecing together. A biological pathway is a common way of representing a biological story pictorially. The present invention provides a PathwayEditor component, which is used to put together a biological story pictorially. An analogy can be drawn here to Computer-Aided Circuit Design (CAD) software, particularly to CAD schematic capture tools, in that the biologist uses the PathwayEditor to sketch out a representation of the “circuitry” of a biological pathway.

The PathwayEditor component consists of a canvas on the right and a set of buttons on the left for adding elements. In the PathwayEditor component, the investigator can put together diagrams representing the relationships between biological entities. These biological entities and their relationships can be thought of as the “nouns” and “verbs” of the biological story. In the present invention, the “nouns” are represented by items and collections. The pictorial story is built up by dragging/dropping items and/or collections onto the PathwayEditor panel. A graphical icon, representing the item or collection, appears at the drop point. There are a set of pre-defined “verbs” which are used to specify a relationship between “nouns”, for example Inhibits, Promotes, or BindsTo.

Two “nouns” are connected with a “verb” by selecting the “verb” on the menu (e.g. by pressing a button labeled Promotes), then drawing a line between the two graphical icons representing the “nouns.” Drawing is accomplished by positioning the mouse sprite over the first icon, pressing down on the mouse button, dragging the mouse sprite over to the second icon, then releasing the mouse button. A color-encoded arrow appears, connecting the two graphic icons, for example a red line represents the Inhibits “verb.” “Verbs” in the PathwayEditor are directional; that is, a red arrow running from item A to item B indicates that “A Inhibits B,” but not the converse.

There is a duality between graphical and textual storytelling. A textual story may be generated from the contents of the PathwayEditor component. The current invention includes a parser that recognizes “nouns” and “verbs” in the PathwayEditor and generates a textual biological story consisting of Characters (for “nouns”) and Events (for “verbs”). The resulting text story is structurally equivalent to one that could have been entered via the StoryEditor.

### Semantic Overlays

Often it is useful to overlay items, collections, and biological stories with detailed experimental data, for example overlaying a set of expression levels on the Characters in a biological story and highlighting those genes whose expression levels exceed a certain threshold. This is analogous to the facilities in CAD tools for simulating circuit behavior; thus, the software provides a method for informally testing the hypotheses represented in biological stories. Such overlays are semantic, in that the meanings of the data, rather than their visual representations, are juxtaposed.

The present invention provides a method for constructing semantic overlays in the PathwayEditor component. If the items in the Gene Manager contain sets of expression levels from microarray experiments, then the biologist can “step through” each column of expression data and visualize the expression levels, color-coded on top of the icons for those items in the PathwayEditor. Such “simulations” can be useful, for example, in inferring relationships between items, such as causal relationships inferred by “stepping through” time course data.

### Organizing and Sharing Diverse Biological Information

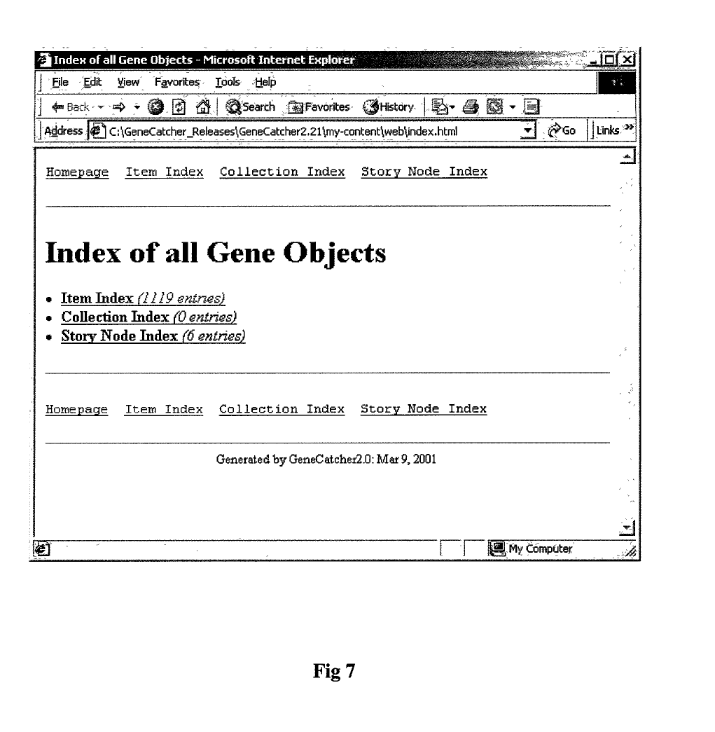

The present invention uses generated Web pages to represent the detailed information contained in items and collections. The software generates an interlinked set 5 of Web pages, each item, each collection, and each element of a story having their own Web pages. When new information is associated with an item or collection, for example by dragging and dropping (or cutting/copying and pasting) a literature citation onto an item, that new information is incorporated into the Web page for that item. The investigator can navigate through this biological information space by selecting and following the links on the Web pages for items, collections, and stories. Such links are shown for example in FIG. 2. In addition to a specific Web page for each item, collection, and story node, there are index Web pages, one for the set of all items, one for the set of all collections, and one for the set of all story nodes shown in FIG. 7. A Web repository for a dataset is created by selecting the Publish To Web menu item on the File menu.

The program provides an ObjectEditor interface for editing and annotating the properties and contents of items and collections. The ObjectEditor tool is a form-based editor. By typing into fields in these forms, the biologist can add arbitrary annotations to the item or collection, as well as add annotations for each link to detailed information. For example, the biologist may want to add, as an annotation, a simple phrase that summarizes the main points of a literature citation.

While the program will be useful for an individual biologist in keeping track of information while building up explanations and hypotheses, some of its real power derives from the ability of the biologist to share biological stories with colleagues and collaborators. This is a way for the biologist to share the state of his/her thinking, receive feedback from colleagues, incorporate that feedback into the state of thinking, and, thus, refine the state of his/her thinking.

To support the sharing of biological stories, the present invention generates a Web page for every node that appears in the StoryEditor. Thus, every biological story can have its own Web page. The Characters displayed on the Web page for the biological story contain links to the Web pages for the items and collections represented by the Characters in the biological story. Thus, a person that visits the Web page for a biological story can navigate throughout the entire context surrounding that biological story. The Web page is a richly interconnected map of the biologist's train of thinking in building up a particular set of explanations and/or hypotheses.

If a colleague is using the program, rather than a Web browser, for viewing a biological story, then this colleague can serve as a “reviewer” and add annotations. This is done using the Comment node. The “reviewer” can add a Comment node to any node in a biological story, by pressing on the Comment button in the StoryEditor component and typing into the text panel of the StoryEditor component. The software tags such comments with the “reviewer's” name, so that annotations from different colleagues can be distinguished.

### Saving Work in Progress

The state of work is saved by invoking the Save item on the File menu shown in FIG. 3. All items, collections, and stories are written to persistent storage, using XML Web technology described at [http://w3.org]. All the links to detailed information associated with the items, collections, and stories are saved along with them. Other contextual information, such as the coordinates of icons placed in the Desktop component, are also saved. All this information is restored the next time the program is run.

For safety purposes, the software will also prompt to save changes upon exiting the program. Invoking the Quit item on the File menu shown in FIG. 3 also causes the software to display a dialog box, asking to save changes.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. A system for organizing information across external information objects comprising:
An Item Manager for creating items representing external information objects,
A Collection Manager for creating and manipulating collections of items,
A Story Editor based on a narrative grammar for incorporating items and collections into the narrative grammar.

2. The system of claim 1 where the Item Manager additionally supports the display and annotation of items.

3. The system of claim 1 where the Collection Manager additionally supports the display and annotation of collections.

4. The system of claim 1 where the items included in a collection may include other collections.

5. The system of claim 1 where an update made to a component such as an item, collection, or story is automatically reflected in connected components.
